(19) United States
(12) Patent Application Publication
(10) Pub. No.: US 2026/0082218 A1
(43) Pub. Date: Mar. 19, 2026

(54) KEY FOR CONNECTIVITY TO A CELL GROUP

(71) Applicant: Lenovo (Singapore) Pte. Limited, Singapore (SG)

(72) Inventors: Prateek Basu Mallick, Dreieich (DE); Joachim Löhr, Wiesbaden (DE); Ravi Kuchibhotla, Chicago, IL (US); Hyung-Nam Choi, Ottobrunn (DE)

(73) Assignee: Lenovo (Singapore) Pte. Limited, Singapore (SG)

(21) Appl. No.: 19/109,663

(22) PCT Filed: Sep. 15, 2023
(86) PCT No.: PCT/IB2023/059197

§ 371 Date: Mar. 7, 2025

Related U.S. Application Data
(60) Provisional application No. 63/407,497, filed on Sep. 16, 2022.

(51) Int. Cl. H04W 12/043; H04W 12/041; H04W 36/00; H04W 36/30

(52) U.S. Cl. CPC H04W 12/043; H04W 12/041; H04W 36/0085; H04W 36/30

(57) ABSTRACT

Various aspects of the present disclosure relate to methods, apparatuses, and systems that support key for connectivity to a cell group. For instance, implementations provide ways for a UE to securely switch connectivity from a first SCG associated with a master cell group (MCG) to a second SCG associated with the MCG. The UE, for example, has previously connected to (e.g., visited) the second SCG. The UE informs the MCG of the upcoming connectivity switch. Accordingly, the MCG uses a security counter value to generate a new secondary key and the MCG transmits the security counter value to the UE. Further, the MCG transmits the new secondary key to the second SCG. Thus, the UE can generate the secondary key using the security counter value and the UE and the second SCG can transmit and receive data using the secondary key.

### RELATED APPLICATION

This application claims priority to U.S. Provisional Application Ser. No. 63/407,497 filed 16 Sep. 2022 entitled “KEY FOR CONNECTIVITY TO A CELL GROUP,” the disclosure of which is incorporated by reference herein in its entirety.

### TECHNICAL FIELD

The present disclosure relates to wireless communications, and more specifically to security in wireless communications.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Some wireless communications systems provide ways for UE mobility between cells, such as between secondary cells associated with a master cell group. However, some techniques for UE mobility experience delay and overhead challenges that may reduce wireless performance with switching connectivity between cells.

### SUMMARY

The present disclosure relates to methods, apparatuses, and systems that support key for connectivity to a cell group. For instance, a UE determines to switch connectivity from a first secondary cell group (SCG) associated with a master cell group (MCG) to a second SCG associated with the MCG. The UE, for example, has previously connected to (e.g., visited) the second SCG. The UE informs the MCG (e.g., a primary cell (PCell) of the MCG) of the upcoming connectivity switch. In at least one implementation, the connectivity switch represents an impending Layer 1/Layer 2 (L1/L2) mobility of the UE from the first SCG to the second SCG. Accordingly, the MCG uses a security counter value (e.g., sk-counter) to generate a new secondary key (e.g., from a master key of the MCG using the security counter value) and the MCG transmits the security counter value to the UE. Further, the MCG transmits the new secondary key to the second SCG. Thus, the UE can generate the secondary key using the security counter value and the UE and the second SCG can transmit and receive data using the secondary key. In additional or alternative implementations, a UE can inform a master node (MN) of an MCG of an impending mobility to an already visited PSCell and/or SCG, and the MCG can initiate an intra-cell handover procedure to initiate a refresh of a master key, e.g., KgNB. In additional or alternative implementations, a UE and an SCG increment a security counter value for each visit of the UE to the SCG.

By utilizing the described techniques, latency, overhead, and interruption time issues experienced with other types of UE mobility are reduced. Further, security vulnerabilities that may occur with lower level (e.g., L1/L2) mobility implementations are mitigated.

Some implementations of the methods and apparatuses described herein may further include initiating, by a user equipment (UE), a connectivity procedure to connect to a secondary cell of a first cell group; updating a security counter value associated with the first cell group based at least in part on an indication that the UE previously connected to a different cell group; generating, based at least in part on the updated security counter value, a security key for the first cell group; and implementing data transmission to the secondary cell of the first cell group using the security key.

Some implementations of the methods and apparatuses described herein may further include: receiving configuration information for connectivity between multiple cell groups, where the configuration information includes the security counter value for the first cell group and one or more other security counter values for one or more other cell groups of the multiple cell groups; determining that the UE previously connected to a different cell group subsequently to receiving the configuration information; and generating the security key using the updated security counter value based at least in part on the determination that the UE previously connected to a different cell group subsequently to receiving the configuration information.

Some implementations of the methods and apparatuses described herein may further include: receiving the configuration information from a master cell group, where the configuration information includes configuration information for primary secondary cells for the multiple cell groups; performing one or more measurements of one or more measurement objects associated with the first cell group; and initiating the connectivity procedure based on least in part on the one or more measurements corresponding to a criterion; receiving radio resource control (RRC) configuration identifying the one or more measurement objects; initiating the connectivity procedure via a lower level mobility procedure; the updated security counter value includes a security counter value not previously used by the UE for connectivity to the first cell group; implementing the data transmission using the security key to secure data transmission over one or more bearers served by the first cell group; to update the security counter value; incrementing the security counter value to generate the updated security counter value; receiving a specified offset value, and incrementing the security counter value by the specified offset value to generate the updated security counter value.

Some implementations of the methods and apparatuses described herein may further include receiving an indication that a user equipment (UE) initiates a connectivity procedure to connect to a secondary cell of a first cell group; transmitting, to the first cell group, a security key; and transmitting, to the UE, a security counter value used to generate the security key.

Some implementations of the methods and apparatuses described herein may further include: transmitting, to the UE, configuration information for connectivity between multiple cell groups, where the configuration information includes the security counter value for the first cell group and one or more other security counter values for one or more other cell groups of the multiple cell groups; the methods and apparatuses are implemented by a master node of a master cell group, and where the configuration information includes configuration information for primary secondary cells for the multiple cell groups; generate the security counter value for the first cell group and the one or more other security counter values for the one or more other cell groups as non-contiguous values; receiving the indication that the UE initiates the connectivity procedure while the UE is connected to a second secondary cell group of the multiple cell groups; transmitting the configuration information to the UE via RRC signaling; transmitting, to the UE, configuration information including one or more measurement objects and one or more criteria for connectivity to the secondary cell of the first cell group; the indication indicates that the UE initiates the connectivity procedure via a lower layer mobility procedure; the indication indicates that the UE previously connected to the secondary cell of the first cell group.

Some implementations of the methods and apparatuses described herein may further include transmitting, by a user equipment (UE) and to a master node of a master cell group, an indication that the UE initiates a connectivity procedure to connect to a secondary cell of a first cell group; receiving a notification to perform an intra-cell handover with a primary cell of the master cell group; implementing the intra-cell handover with the primary cell using a master key generated using a received next hop count; receiving a security counter value from the primary cell; and generating a security key using the security counter value and implement data transmission to the secondary cell of the first cell group using the security key.

Some implementations of the methods and apparatuses described herein may further include: the indication further indicates that the UE previously connected to the secondary cell of the first cell group; receiving multiple security counter values for multiple secondary cells groups including the first cell group; the notification to perform the intra-cell handover includes an indication to use the primary cell as both a source cell and a target cell for the intra-cell handover.

Some implementations of the methods and apparatuses described herein may further include receiving, at a primary cell of a master cell group, an indication that a user equipment (UE) initiates a connectivity procedure to connect to a secondary cell of a first cell group; initiating an intra-cell handover between the UE and the primary cell of the master cell group to generate an updated master key of the master cell group using a next hop count; transmitting, to the first cell group, a secondary key generated based at least in part on the updated master key; and transmitting a security counter value used to generate the secondary key to the UE.

Some implementations of the methods and apparatuses described herein may further include: to initiate the intra-cell handover, transmitting a notification to the UE to use the primary cell as both a source cell and a target cell for the intra-cell handover; the master cell group includes multiple cell groups, and transmitting, to the UE, multiple security counter values for the multiple cell groups.

Some implementations of the methods and apparatuses described herein may further include receiving, at a first cell group and from a master cell group, a security counter value; receiving an indication that a user equipment (UE) initiates a connectivity procedure to connect to a secondary cell of the first cell group; incrementing the security counter value to generate an updated security counter value; and implementing data transmission with the UE using a security key generated using the updated security counter value.

Some implementations of the methods and apparatuses described herein may further include: receiving a specified offset value, and incrementing the security counter value by the specified offset value to generate the updated security counter value; determining that the UE previously connected to the first cell group using the security counter value; determining that the connectivity procedure represents a reconnection of the UE to the first cell group; and incrementing the security counter value to generate the updated security counter value based at least in part on the reconnection of the UE to the first cell group.

### BRIEF DESCRIPTION OF THE DRAWINGS

FIG. 1 illustrates an example of a wireless communications system that supports key for connectivity to a cell group in accordance with aspects of the present disclosure.

FIG. 2 illustrates a system for inter-gNB handover procedures.

FIG. 3 illustrates a system for intra-AMF and UPF handover.

FIG. 4 illustrates a system that supports key for connectivity to a cell group in accordance with aspects of the present disclosure.

FIG. 5 illustrates a system that supports key for connectivity to a cell group in accordance with aspects of the present disclosure.

FIG. 6 illustrates a system that supports key for connectivity to a cell group in accordance with aspects of the present disclosure.

FIGS. 7 and 8 illustrate different respective portions of a message that supports key for connectivity to a cell group in accordance with aspects of the present disclosure.

FIGS. 9 and 10 illustrate examples of block diagrams of devices that support key for connectivity to a cell group in accordance with aspects of the present disclosure.

FIGS. 11 through 17 illustrate flowcharts of methods that support key for connectivity to a cell group in accordance with aspects of the present disclosure.

### DETAILED DESCRIPTION

In wireless communications systems, when a UE moves from the coverage area of one cell (e.g., SCG) to another cell, a serving cell change may be performed, e.g., where a current serving cell does not remain a radio viable option. In some implementations, a serving cell change of a UE is triggered by layer 3 (L3) measurements and is implemented via RRC signalling-triggered reconfiguration with synchronisation for a change of PCell and PSCell, as well as release add for SCells when applicable. Such scenarios typically involve complete L2 and L1 resets, leading to longer latency, larger overhead, and longer interruption time than beam switch mobility. Some proposals for L1/L2 mobility enhancements to enable a serving cell change via L1/L2 signalling have been presented. However, such proposals fail to address security vulnerabilities that may be introduced in lower layer (e.g., L1/L2) implementations for UE mobility between serving cells.

Accordingly, this disclosure provides for techniques that support key for connectivity to a cell group. For instance, implementations provide performant and secure ways for UE mobility between different cells, such as different SCGs associated with an MCG. In implementations, a UE determines to switch connectivity from a first SCG associated with a master cell group (MCG) to a second SCG associated with the MCG. The UE, for example, has previously connected to (e.g., visited) the second SCG. The UE informs the MCG (e.g., a primary cell (PCell) of the MCG) of the upcoming connectivity switch. In at least one implementation, the connectivity switch represents an impending L1/L2 mobility of the UE from the first SCG to the second SCG. Accordingly, the MCG uses a security counter value (e.g., sk-counter) to generate a new secondary key (e.g., from a master key of the MCG using the security counter value) and the MCG transmits the security counter value to the UE. Further, the MCG transmits the new secondary key to the second SCG. Thus, the UE can generate the secondary key using the security counter value and the UE and the second SCG can transmit and receive data using the secondary key. Further, the UE use the security counter value sequentially, such as one value for each visit of the UE to the second SCG.

In additional or alternative implementations, a UE can inform a MN of an MCG of an impending mobility to an already visited PSCell and/or SCG, and the MCG can initiate an intra-cell handover procedure to initiate a refresh of a master key, e.g., K_{gNB}. After receiving the intra-cell handover command (e.g., upon receiving RRCReconfiguration message with reconfigurationWithSync for a handover to the source cell), the UE can update the K_{gNB} key based on the current K_{gNB} key and/or the Next Hop Key (NH), using the nextHopChainingCount value (e.g., next hop count value) received in the reconfiguration message. The UE can replace the nextHopChainingCount with the value of nextHopChainingCount received and derive the keys associated with the K_{gNB} key as follows:
derive the K_{RRCenc} and K_{UPenc} keys associated with the current cipheringAlgorithm;
derive the K_{RRCint} and K_{UPint} keys associated with the current integrityProtAlgorithm.

The MN can derive the new S-K_{gNB} for each SCG and send it to the respective SCGs. The UE can be sent the new sk-counter(s) for each of the SCGs, and can also generate S-K_{gNB} for each SCG when performing mobility to it.

In additional or alternative implementations, a UE and an SCG increment a security counter value for each visit of the UE to the SCG. The UE and the SCG, for instance, increment the security counter value by 1 and/or by a signaled offset value for each instance of the UE visiting the SCG.

Thus, by utilizing the described techniques, latency, overhead, and interruption time issues experienced with other types of UE mobility are reduced. Further, security vulnerabilities that may occur with lower level (e.g., L1/L2) mobility implementations are mitigated.

Aspects of the present disclosure are described in the context of a wireless communications system. Aspects of the present disclosure are further illustrated and described with reference to device diagrams and flowcharts.

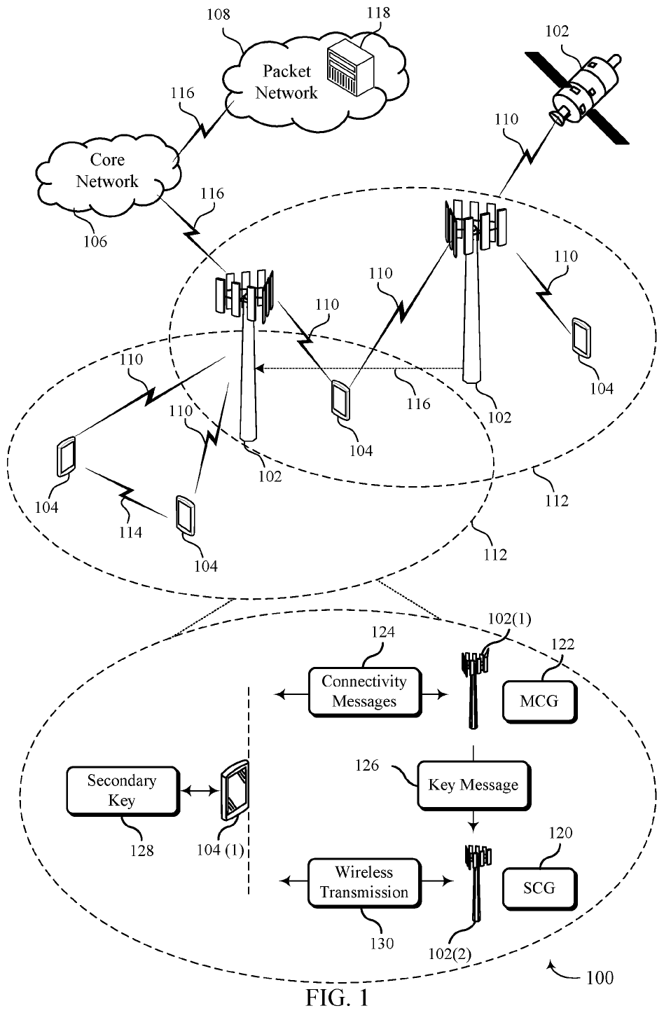

FIG. 1 illustrates an example of a wireless communications system 100 that supports key for connectivity to a cell group in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, V2X deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-real time (RT) RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., RRC, service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, media access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a PDU session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (e.g., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency-division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations for key for connectivity to a cell group, a UE 104(1) determines to switch connectivity to a SCG 120. The UE 104(1), for instance, determines that the SCG 120 can provide higher quality wireless connectivity than a current secondary cell group, and/or the UE 104(1) physically moves toward the SCG 120. Accordingly, the UE 104(1) and a network entity 102(1) of an MCG 122 transmit connectivity messages 124 to enable the UE 104(1) to transmit and receive data with the SCG 120. As part of the connectivity messages 124, for example, the UE 104(1) notifies the MCG 122 that the UE 104(1) implements mobility toward the SCG 120 to connect to the SCG 120. Further, as part of the connectivity messages 124, the MCG 122 transmits a security counter value to the UE 104(1). The MCG 122, for example, utilizes the security counter value to generate a secondary key (e.g., from a master key of the MCG 122) and transmits a key message 126 to a network entity 102(1) of the SCG 120.

Accordingly, the UE 104(1) uses the security counter value to generate the secondary key 128, and the UE 104(1) and the SCG 120 can utilize the secondary key 128 for wireless transmission 130, e.g., to transmit and receive data between the UE 104(1) and the SCG 120.

In some wireless communications systems, conditional PSCell change (CPC)/Conditional PSCell addition (CPA), a CPC/CPA-configured UE is to release the CPC/CPA configurations when completing random access towards a target PSCell. Thus the UE may not have an opportunity to perform subsequent CPC/CPA without prior CPC/CPA reconfiguration and re-initialization from the network. This may increase a delay for the cell change and increase the signalling overhead, such as in the case of frequent SCG changes when operating FR2. Therefore, multi-RAT (MR)-dual connectivity (DC)(MR-DC) with selective activation of cell groups aims at enabling subsequent CPC/CPA after SCG change, without reconfiguration and re-initialization on the CPC/CPA preparation from the network. This may result in a reduction of the signalling overhead and interrupting time for SCG change.

Currently, conditional handover (CHO) and MR-DC cannot be configured simultaneously. This limits the usefulness of these two features when MR-DC is configured. However, this alone may not be sufficient to optimise MR-DC mobility, as the radio link quality of the conditionally-configured PSCell may not be sufficient or may not be the best candidate PSCell when the UE accesses the target PCell, and this may impact the UE throughput. To mitigate this throughput impact, some implementations for CHO+MRDC can consider CHO including target MCG and multiple candidate SCGs for CPC/CPA.

Further to some wireless communications systems, network-controlled mobility can apply to UEs in an RRC_CONNECTED state and can be categorized into two types of mobility: cell level mobility and beam level mobility. Beam level mobility can include intra-cell beam level mobility and inter-cell beam level mobility.

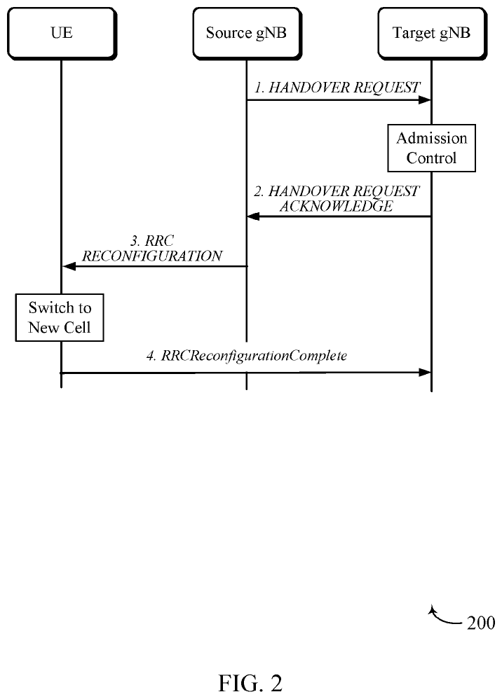

FIG. 2 illustrates a system 200 for inter-gNB handover procedures. In different scenarios, cell level mobility involves triggering of explicit RRC signalling, e.g., for handover. For inter-gNB handover, the signalling procedures may consist of at least the elemental components illustrated in the system 200, as described below:

1. The source gNB initiates handover and issues a HANDOVER REQUEST over the Xn interface.

2. The target gNB performs admission control and provides the new RRC configuration as part of the HANDOVER REQUEST ACKNOWLEDGE.

3. The source gNB provides the RRC configuration to the UE by forwarding the RRCReconfiguration message received in the HANDOVER REQUEST ACKNOWLEDGE. The RRCReconfiguration message includes at least cell identifier (ID) and information required to access the target cell so that the UE can access the target cell without reading system information. For some cases, the information required for contention-based and contention-free random access can be included in the RRCReconfiguration message. The access information to the target cell may include beam specific information, if any.

4. The UE moves the RRC connection to the target gNB and replies with the RRCReconfigurationComplete. In implementations, user data can also be sent in step 4 if the grant allows.

In scenarios for dual active protocol stack (DAPS) handover, the UE can continue the downlink user data reception from the source gNB until releasing the source cell and can continue the uplink user data transmission to the source gNB until successful random-access procedure to the target gNB. Further, source and target PCell can be used during DAPS handover. Carrier aggregation (CA), DC, Supplementary Uplink (SUL), multi-TRP, EHC, CHO, Unified Data Convergence (UDC), NR sidelink configurations and V2X sidelink configurations can be released by the source gNB before the handover command is sent to the UE and may not be configured by the target gNB until the DAPS handover has completed, e.g., at earliest in the same message that releases the source PCell.

The handover mechanism triggered by RRC may involve the UE to at least reset the MAC entity and re-establish RLC, except for DAPS handover, where upon reception of the handover command, the UE can:
Create a MAC entity for target;
Establish the RLC entity and an associated dedicated traffic channel (DTCH) logical channel for target for each data radio bearer (DRB) configured with DAPS;
For each DRB configured with DAPS, reconfigure the PDCP entity with separate security and Robust Header Compression (ROHC) functions for source and target and associates them with the RLC entities configured by source and target respectively;
Retain the rest of the source configurations until release of the source.

In some wireless communications systems, RRC managed handovers with and without PDCP entity re-establishment can both be supported. For DRBs using RLC acknowledged mode (AM) mode, PDCP can either be re-established together with a security key change or initiate a data recovery procedure without a key change. For DRBs using RLC Unacknowledged Mode (UM) mode, PDCP can either be re-established together with a security key change or remain as it is without a key change. For SRBs, PDCP can either remain as it is, discard its stored PDCP PDUs/SDUs without a key change or be re-established together with a security key change.

Data forwarding, in-sequence delivery and duplication avoidance at handover, can be successful when the target gNB uses the same DRB configuration as the source gNB. Timer based handover failure procedure can be supported in NR. RRC connection re-establishment procedure can be used for recovering from handover failure except in certain CHO or DAPS handover scenarios:
When DAPS handover fails, the UE can fall back to the source cell configuration, resume the connection with the source cell, and report DAPS handover failure via the source without triggering RRC connection re-establishment if the source link has not been released.
When initial CHO execution attempt fails or handover fails, the UE can perform cell selection, and if the selected cell is a CHO candidate and if network configured the UE to try CHO after handover/CHO failure, then the UE can attempt CHO execution once, otherwise re-establishment can be performed.

In some scenarios the handover of the Integrated Access and Backhaul (IAB)-mobile terminated (MT) in standalone mode follows the same procedure as described for the UE. After the backhaul has been established, the handover of the IAB-MT is part of an intra-CU topology adaptation procedure. Modifications to the configuration of backhaul adaption protocol (BAP) sublayer and higher protocol layers above the BAP sublayer can be implemented.

In some wireless communications scenarios beam level mobility does not require explicit RRC signalling to be triggered. For instance, beam level mobility can be within a cell or between cells, and the latter is referred to as inter-cell beam management (ICBM). For ICBM, a UE can receive or transmit UE dedicated channels/signals via a TRP associated with a Physical Cell Identity (PCI) different from the PCI of a serving cell, while non-UE-dedicated channels/signals may be received via a TRP associated with a PCI of the serving cell. A gNB can provide via RRC signalling the UE with measurement configuration containing configurations of SS/PBCH block (SSB)/channel state information (CSI) resources and resource sets, reports and trigger states for triggering channel and interference measurements, and reports. In case of ICBM, a measurement configuration can include SSB resources associated with PCIs different from the PCI of a serving cell. Beam level mobility can then be dealt with at lower layers by means of physical layer and MAC layer control signalling, and RRC may not be required to know which beam is being used at a given point in time.

In scenarios, SSB-based Beam Level Mobility is based on the SSB associated to the initial downlink (DL) bandwidth part (BWP) and can be configured for the initial DL BWPs and for DL BWPs containing the SSB associated to the initial DL BWP. For other DL BWPs, Beam level mobility can be performed based on CSI-reference signal (RS).

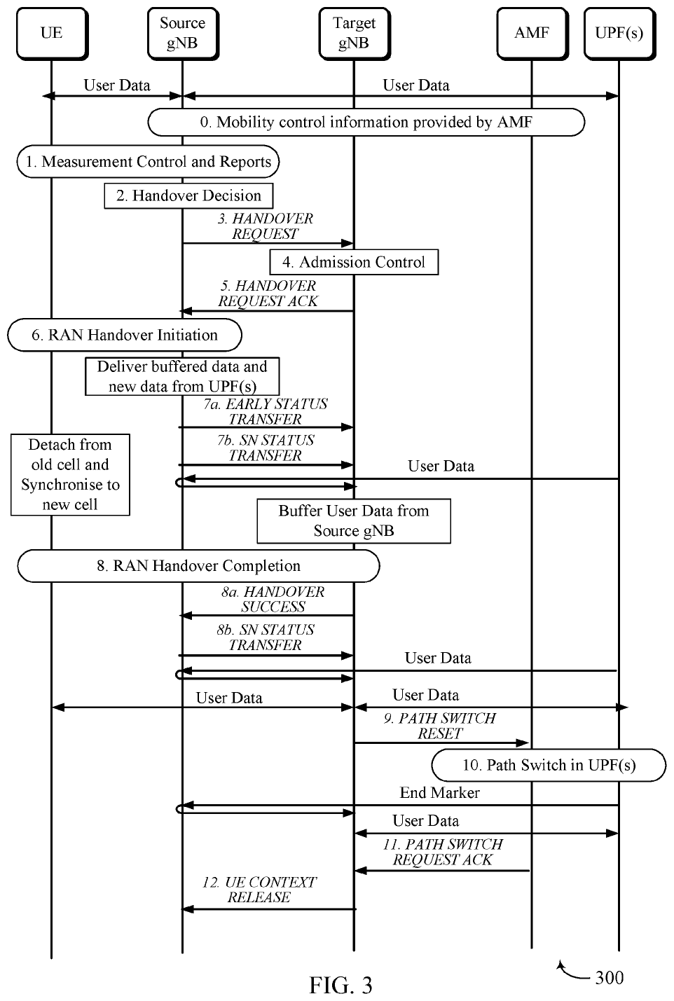

FIG. 3 illustrates a system 300 for intra-AMF and UPF handover. In some scenarios, an intra-NR RAN handover performs the preparation and execution phase of the handover procedure performed without involvement of the 5GC, e.g., preparation messages are directly exchanged between the gNBs. The release of the resources at the source gNB during the handover completion phase can be triggered by the target gNB. The system 300 depicts a handover scenario where neither the AMF nor the UPF changes:

0. The UE context within the source gNB contains information regarding roaming and access restrictions which were provided either at connection establishment or at the last Timing Advance (TA) update.

1. The source gNB configures the UE measurement procedures and the UE reports according to the measurement configuration.

2. The source gNB decides to handover the UE, based on MeasurementReport and Radio Resource Management (RRM) information.

3. The source gNB issues a Handover Request message to the target gNB passing a transparent RRC container with necessary information to prepare the handover at the target side. The information includes at least the target cell ID, KgNB*, the Cell Radio Network Temporary Identifier (C-RNTI) of the UE in the source gNB, RRM-configuration including UE inactive time, basic access stratum (AS)-configuration including antenna Info and DL Carrier Frequency, the current QoS flow to DRB mapping rules applied to the UE, the SIB1 from source gNB, the UE capabilities for different RATs, PDU session related information, and can include the UE reported measurement information including beam-related information if available. The PDU session related information includes the slice information and QoS flow level QoS profile(s). The source gNB may also request a DAPS handover for one or more DRBs. In some scenarios, after issuing a Handover Request, the source gNB is not to reconfigure the UE, including performing Reflective QoS flow to DRB mapping.

4. Admission Control may be performed by the target gNB. Slice-aware admission control can be performed if the slice information is sent to the target gNB. If the PDU sessions are associated with non-supported slices the target gNB can reject such PDU Sessions.

5. The target gNB prepares the handover with L1/L2 and sends the HANDOVER REQUEST ACKNOWLEDGE to the source gNB, which includes a transparent container to be sent to the UE as an RRC message to perform the handover. The target gNB also indicates if a DAPS handover is accepted.
NOTE 2: As soon as the source gNB receives the HANDOVER REQUEST ACKNOWLEDGE, or as soon as the transmission of the handover command is initiated in the downlink, data forwarding may be initiated.
NOTE 3: For DRBs configured with DAPS, downlink PDCP SDUs are forwarded with Sequence Number (SN) assigned by the source gNB, until SN assignment is handed over to the target gNB in step 8b, for which the normal data forwarding follows specified procedures.

6. The source gNB triggers the Uu handover by sending an RRCReconfiguration message to the UE, containing the information used to access the target cell: at least the target cell ID, the new C-RNTI, and the target gNB security algorithm identifiers for the selected security algorithms. It can also include a set of dedicated random access channel (RACH) resources, the association between RACH resources and SSB(s), the association between RACH resources and UE-specific CSI-RS configuration(s), common RACH resources, and system information of the target cell, etc.
NOTE 4: For DRBs configured with DAPS, the source gNB may not stop transmitting downlink packets until it receives the HANDOVER SUCCESS message from the target gNB in step 8a.
NOTE 4a: CHO may not be configured simultaneously with DAPS handover. 7a. For DRBs configured with DAPS, the source gNB sends the EARLY STATUS TRANSFER message. The DL COUNT value conveyed in the EARLY STATUS TRANSFER message indicates PDCP SN and hyper frame number (HFN) of the first PDCP Service Data Unit (SDU) that the source gNB forwards to the target gNB. The source gNB does not stop assigning SNs to downlink PDCP SDUs until it sends the SN STATUS TRANSFER message to the target gNB in step 8b.

7. For DRBs not configured with DAPS, the source gNB sends the SN STATUS TRANSFER message to the target gNB to convey the uplink PDCP SN receiver status and the downlink PDCP SN transmitter status of DRBs for which PDCP status preservation applies (i.e. for RLC AM). The uplink PDCP SN receiver status includes at least the PDCP SN of the first missing uplink (UL) PDCP SDU and may include a bit map of the receive status of the out of sequence UL PDCP SDUs that the UE needs to retransmit in the target cell, if any. The downlink PDCP SN transmitter status indicates the next PDCP SN that the target gNB can assign to new PDCP SDUs, not having a PDCP SN yet.
NOTE 5: In case of DAPS handover, the uplink PDCP SN receiver status and the downlink PDCP SN transmitter status for a DRB with RLC-AM and not configured with DAPS may be transferred by the SN STATUS TRANSFER message in step 8b instead of step 7.
NOTE 6: For DRBs configured with DAPS, the source gNB may additionally send the EARLY STATUS TRANSFER message(s) between step 7 and step 8b, to inform discarding of already forwarded PDCP SDUs. The target gNB may not transmit forwarded downlink PDCP SDUs to the UE, whose COUNT is less than the conveyed DL COUNT value and discards them if transmission has not been attempted already.

8. The UE synchronises to the target cell and completes the RRC handover procedure by sending RRCReconfigurationComplete message to target gNB. In case of DAPS handover, the UE does not detach from the source cell upon receiving the RRCReconfiguration message. The UE releases the source resources and configurations and stops DL/UL reception/transmission with the source upon receiving an explicit release from the target node.
NOTE 6a: From RAN point of view, the DAPS handover is considered to only be completed after the UE has released the source cell as explicitly requested from the target node. RRC suspend, a subsequent handover or inter-RAT handover cannot be initiated until the source cell has been released.

8a/8b In case of DAPS handover, the target gNB sends the HANDOVER SUCCESS message to the source gNB to inform that the UE has successfully accessed the target cell. In return, the source gNB sends the SN STATUS TRANSFER message for DRBs configured with DAPS for which the description in step 7 applies, and the normal data forwarding follows specified procedures.
NOTE 7: The uplink PDCP SN receiver status and the downlink PDCP SN transmitter status are also conveyed for DRBs with RLC-UM in the SN STATUS TRANSFER message in step 8b, if configured with DAPS.
NOTE 8: For DRBs configured with DAPS, the source gNB does not stop delivering uplink QoS flows to the UPF until it sends the SN STATUS TRANSFER message in step 8b. The target gNB does not forward QoS flows of the uplink PDCP SDUs successfully received in-sequence to the UPF until it receives the SN STATUS TRANSFER message, in which UL HFN and the first missing SN in the uplink PDCP SN receiver status indicates the start of uplink PDCP SDUs to be delivered to the UPF. The target gNB does not deliver any uplink PDCP SDUs which has an UL COUNT lower than the provided.

9. The target gNB sends a PATH SWITCH REQUEST message to AMF to trigger 5GC to switch the DL data path towards the target gNB and to establish an NG-C interface instance towards the target gNB.

10. 5GC switches the DL data path towards the target gNB. The UPF sends one or more “end marker” packets on the old path to the source gNB per PDU session/tunnel and then can release any/plane/Transport Network Layer (TNL) resources towards the source gNB.

11. The AMF confirms the PATH SWITCH REQUEST message with the PATH SWITCH REQUEST ACKNOWLEDGE message.

12. Upon reception of the PATH SWITCH REQUEST ACKNOWLEDGE message from the AMF, the target gNB sends the UE CONTEXT RELEASE to inform the source gNB about the success of the handover. The source gNB can then release radio and C-plane related resources associated to the UE context. Any ongoing data forwarding may continue.

According to scenarios, an RRM configuration can include both beam measurement information (for layer 3 mobility) associated to SSB(s) and CSI-RS(s) for the reported cell(s) if both types of measurements are available. Also, if CA is configured, the RRM configuration can include the list of best cells on each frequency for which measurement information is available. And the RRM measurement information can also include the beam measurement for the listed cells that belong to the target gNB.

The common RACH configuration for beams in the target cell may only be associated to the SSB(s). The network can have dedicated RACH configurations associated to the SSB(s) and/or have dedicated RACH configurations associated to CSI-RS(s) within a cell. The target gNB can include one of the following RACH configurations in the Handover Command to enable the UE to access the target cell:
i) Common Rach configuration;
ii) Common RACH configuration+Dedicated RACH configuration associated with SSB;
iii) Common RACH configuration+Dedicated RACH configuration associated with CSI-RS.

In scenarios the dedicated RACH configuration allocates RACH resource(s) together with a quality threshold to use them. When dedicated RACH resources are provided, they can be prioritized by the UE and the UE is not to switch to contention-based RACH resources as long as the quality threshold of those dedicated resources is met. The order to access the dedicated RACH resources can be up to UE implementation.

Upon receiving a handover command requesting DAPS handover, the UE can suspend source cell SRBs, stop sending and receiving any RRC control plane signalling toward the source cell, and establish SRBs for the target cell. The UE can release the source cell SRBs configuration upon receiving source cell release indication from the target cell after successful DAPS handover execution. When DAPS handover to the target cell fails and if the source cell link is available, then the UE can revert back to the source cell configuration and resume source cell SRBs for control plane signalling transmission.

In scenarios the mobility procedure (handover) can depend on the measurements from the UE. The measurement configuration can include the following parameters:

1. Measurement objects: A list of objects on which the UE can perform the measurements.
For intra-frequency and inter-frequency measurements a measurement object indicates the frequency/time location and subcarrier spacing of reference signals to be measured. Associated with this measurement object, the network may configure a list of cell specific offsets, a list of ‘exclude-listed’ cells and a list of ‘allow-listed’ cells. Exclude-listed cells may not be applicable in event evaluation or measurement reporting. Allow-listed cells are applicable in event evaluation or measurement reporting.
The measObjectId of the mobile originated (MO) which corresponds to each serving cell is indicated by servingCellMO within the serving cell configuration.
For inter-RAT E-UTRA measurements a measurement object is a single E-UTRA carrier frequency. Associated with this E-UTRA carrier frequency, the network can configure a list of cell specific offsets and a list of ‘exclude-listed’ cells. Exclude-listed cells may not be applicable in event evaluation or measurement reporting.
For inter-RAT UTRA-Frequency Division Duplexing (FDD) measurements a measurement object is a set of cells on a single UTRA-FDD carrier frequency.
For NR sidelink measurements of L2 U2N Relay UEs, a measurement object is a single NR sidelink frequency to be measured.
For contention based random access channel (RACH) access (CBRA) measurement of NR sidelink communication, a measurement object is a set of transmission resource pool(s) on a single carrier frequency for NR sidelink communication.
For CBRA measurement of NR sidelink discovery, a measurement object is a set of discovery dedicated resource pool(s) or transmission resource pool(s) also used for NR sidelink discovery on a single carrier frequency for NR sidelink discovery.
For cross-link interference (CLI) measurements a measurement object indicates the frequency/time location of Sounding Reference Signal (SRS) resources and/or CLI-received signal strength indicator (RSSI) resources, and subcarrier spacing of SRS resources to be measured.

2. Reporting configurations: A list of reporting configurations where there can be one or multiple reporting configurations per measurement object. Each measurement reporting configuration can consist of the following:
Reporting criterion: The criterion that triggers the UE to send a measurement report. This can either be periodical or a single event description.
RS type: The RS that the UE uses for beam and cell measurement results (synchronization signal (SS)/physical broadcast channel (PBCH) block or CSI-RS).
Reporting format: The quantities per cell and per beam that the UE includes in the measurement report (e.g. reference signal received power (RSRP)) and other associated information such as the maximum number of cells and the maximum number beams per cell to report.

In case of conditional reconfiguration, each configuration can consist of the following:
Execution criteria: The criteria the UE uses for conditional reconfiguration execution.
RS type: The RS that the UE uses for obtaining beam and cell measurement results (SS/PBCH block-based or CSI-RS-based), used for evaluating conditional reconfiguration execution condition.

3. Measurement identities: For measurement reporting, a list of measurement identities where each measurement identity links one measurement object with one reporting configuration. By configuring multiple measurement identities, more than one measurement object can be linked to the same reporting configuration, as well as to link more than one reporting configuration to the same measurement object. The measurement identity is also included in the measurement report that triggered the reporting, serving as a reference to the network. For conditional reconfiguration triggering, one measurement identity links to exactly one conditional reconfiguration trigger configuration. And up to 2 measurement identities can be linked to one conditional reconfiguration execution condition.

4. Quantity configurations: The quantity configuration defines the measurement filtering configuration used for all event evaluation and related reporting, and for periodical reporting of that measurement. For NR measurements, the network may configure up to 2 quantity configurations with a reference in the NR measurement object to the configuration that is to be used. In each configuration, different filter coefficients can be configured for different measurement quantities, for different RS types, and for measurements per cell and per beam.

5. Measurement gaps: Periods that the UE may use to perform measurements.

According to scenarios, a UE in RRC_CONNECTED maintains a measurement object list, a reporting configuration list, and a measurement identities list according to specified signalling and procedures. The measurement object list possibly includes NR measurement object(s), CLI measurement object(s), inter-RAT objects, and L2 U2N Relay objects. Similarly, the reporting configuration list can include NR, inter-RAT, and L2 U2N Relay reporting configurations. Any measurement object can be linked to any reporting configuration of the same RAT type. Some reporting configurations may not be linked to a measurement object. Likewise, some measurement objects may not be linked to a reporting configuration.

Some scenarios for enhanced UE mobility may result in that while an MCG remains available, a UE receives configuration for more than one PSCell (or optionally SCG configuration with each PSCell associated to one or more SCells) and may “move” among different PSCells within this group of PSCells, without a change in PCell or Primary/Master cell group. A UE may have more than one Data Radio Bearer (DRB)established and for each DRB it receives a Security Configuration from the master, called SecurityConfig. For a UE provided with an sk-counter, keyToUse can indicate whether the UE uses the master key (K_{gNB}) or the secondary key (S-K_{eNB} or S-K_{gNB}) for a particular DRB. The secondary key can be derived from the master key and sk-Counter. When there is a need to refresh the secondary key (e.g., upon change of MN with K_{gNB}change and/or to avoid COUNT reuse), the security key update can be used. When the UE is in NR-DC, the network may provide a UE configured with an SCG with an sk-Counter, such as when no DRB is setup using the secondary key (S-K_{gNB}) in order to allow the configuration of SRB3. The network can also provide the UE with an sk-Counter, such as if no SCG is configured, when using SN terminated MCG bearers.

Since a security weakening due to L1 L2-based mobility among the groups of PSCells may occur, a security hole may exist in a scenario where a UE returns to a previously visited PSCell and/or SCG before the Master Key K_{gNB} has been changed. This scenario, for example, may result in the same sk-counter being used again with the same K_{gNB}, which may result in a potential security breach such as when other security input parameters (e.g., SN, HFN, Direction, etc.) are reused as well.

Accordingly, solutions are provided in this disclosure to provide techniques for secure lower layer (e.g., L1/L2) based inter-cell mobility for mobility latency reduction. For instance, the described techniques enable a UE to implement lower-layer inter-cell mobility without exposing the UE and the network to security risks that may be caused in such scenarios.

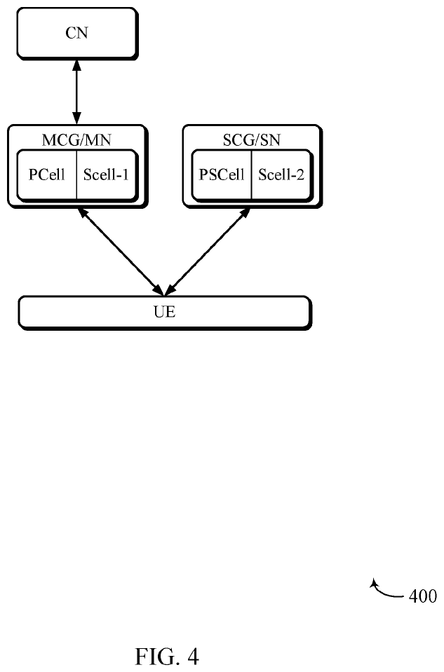

FIG. 4 illustrates a system 400 that supports key for connectivity to a cell group in accordance with aspects of the present disclosure. The system 400, for instance, illustrates a dual connectivity scenario. According to implementations, NG-RAN supports New-Radio Dual Connectivity (NR-DC) operation whereby a UE in RRC_CONNECTED is configured to utilise radio resources provided by two distinct schedulers, located in two different NR nodes, both providing NR access, as shown in the system 400. The first node is called Master Node (MN) and together with one or more cells (SCells) from the Master Node, along with the PCell, this first cell group is called Master Cell Group, or MCG in short. A second node added by the MN to the UE is called Secondary Node (SN); together with one or more cells (SCells) from the Secondary Node, along with the PSCell, this second cell group is called Secondary Cell Group, or SCG in short. When the UE is configured with SCG, the UE is configured with two MAC entities: one MAC entity for the MCG and one MAC entity for the SCG.

Some terms definitions that are applicable to the present disclosure are as follows:

En-gNB: A node providing NR user plane and control plane protocol terminations towards the UE and acting as Secondary Node in E-UTRA-NR Dual Connectivity (EN-DC).

Master Cell Group: in MR-DC, a group of serving cells associated with the Master Node, including the SpCell (PCell) and optionally one or more SCells.

Master node: in MR-DC, the radio access node that provides the control plane connection to the core network. It may be a Master eNB (in EN-DC), a Master ng-eNB (in NG-RAN-E-UTRA-NR Dual Connectivity (NGEN-DC)), a Master gNB (in NR-DC and NR-E-UTRA Dual Connectivity (NE-DC)), and so forth.

MCG bearer: in MR-DC, a radio bearer with an RLC bearer (or two RLC bearers, such in case of CA packet duplication) in the MCG.

MN terminated bearer: in MR-DC, a radio bearer for which PDCP is located in the MN. MCG Signalling Radio Bearer (SRB): in MR-DC, a direct SRB between the MN and the UE.

Multi-Radio Dual Connectivity: Dual Connectivity between E-UTRA and NR nodes, or between two NR nodes.

Next generation eNB (Ng-eNB): node connecting 5G UE to 5G core network (CN) using 4G LTE air interface such as defined in TS 38.300.

PCell: SpCell of a master cell group.

PSCell: SpCell of a secondary cell group.

RLC bearer: RLC and MAC logical channel configuration of a radio bearer in one cell group.

Secondary Cell Group: in MR-DC, a group of serving cells associated with the Secondary Node, comprising of the SpCell (PSCell) and optionally one or more SCells.

Secondary node: in MR-DC, the radio access node, with no control plane connection to the core network, providing additional resources to the UE. It may be an en-gNB (in EN-DC), a Secondary ng-eNB (in NE-DC), or a Secondary gNB (in NR-DC and NGEN-DC).

SCG bearer: in MR-DC, a radio bearer with an RLC bearer (or two RLC bearers, in case of CA packet duplication) in the SCG.

SN terminated bearer: in MR-DC, a radio bearer for which PDCP is located in the SN.

SpCell: primary cell of a master or secondary cell group.

SRB3: in EN-DC, NGEN-DC and NR-DC, a direct SRB between the SN and the UE.

Split bearer: in MR-DC, a radio bearer with RLC bearers both in MCG and SCG.

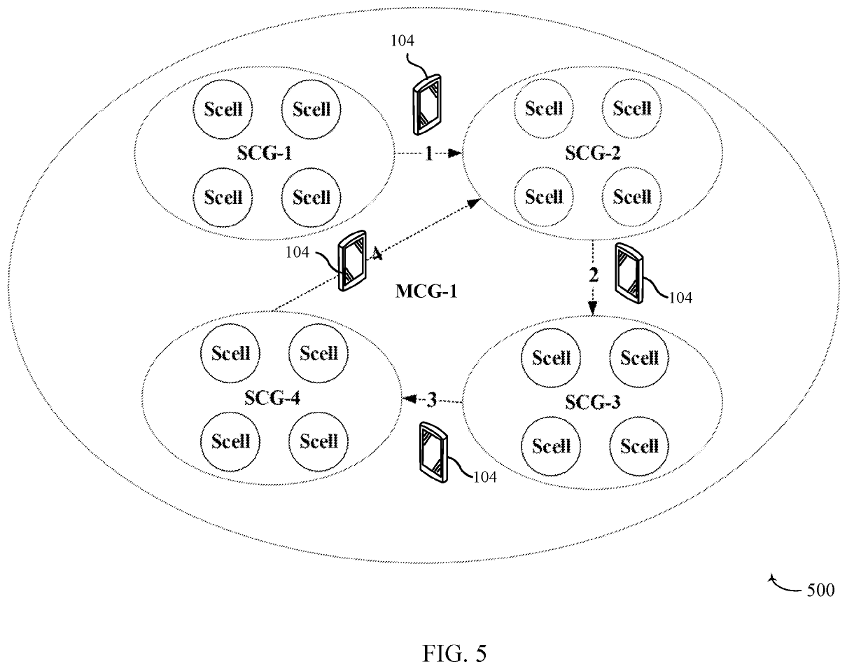

FIG. 5 illustrates a system 500 that supports key for connectivity to a cell group in accordance with aspects of the present disclosure. According to implementations, a UE 104 can receive from the MCG-1 configuration for more than one PSCell (and/or optionally SCG configuration with each PSCell associated to one or more SCells) from the MN and may move (e.g., change connectivity) among different PSCells within this groups of PSCells without a change in PCell or Primary/Master cell group such as illustrated in the system 500. In system 500, for instance, the UE 104 is provided by the MCG-1 with configuration for SCG-1, SCG-2, SCG-3, and SCG-4. For example, the UE 104 may have more than one DRB established and for each it receives a Security Configuration from MCG-1, which can be called SecurityConfig. For a UE 104 provided with an sk-counter, keyToUse can indicate whether the UE uses the master key (K_{gNB}) or the secondary key (S-K_{eNB} or S-K_{gNB}) for a particular DRB. The secondary key can be derived from the master key and sk-Counter. When there is a need to refresh the secondary key (e.g., upon change of MN with K_{gNB} change and/or to avoid COUNT reuse), a security key update can be used. When the UE 104 is in NR-DC, the network may provide a UE configured with an SCG with an sk-Counter such as when no DRB is setup using the secondary key (S-K_{gNB}) to allow the configuration of SRB3. The network can also provide the UE with an sk-Counter, such as if no SCG is configured, when using SN terminated MCG bearers.

A security issue may arise when the UE 104 returns to a previously visited (e.g., previously connected) PSCell and/or SCG. For instance, in the system 500, SCG-2 is being revisited by the UE 104 after UE 104 mobility from SCG-1 to SCG-2 and SCG-3 to SCG-4. In some scenarios, if the MCG (MCG-1) remains the same and there's no update in the Master Key K_{gNB}subsequent to the RRC Configuration being received at the UE 104 configuring the SCGs 1-4, this may result in the same sk-counter being used again with the same K_{gNB}, which can result in a potential security breach such as when other security input parameters (e.g., SN, HFN, Direction, etc.) may be reused as well.

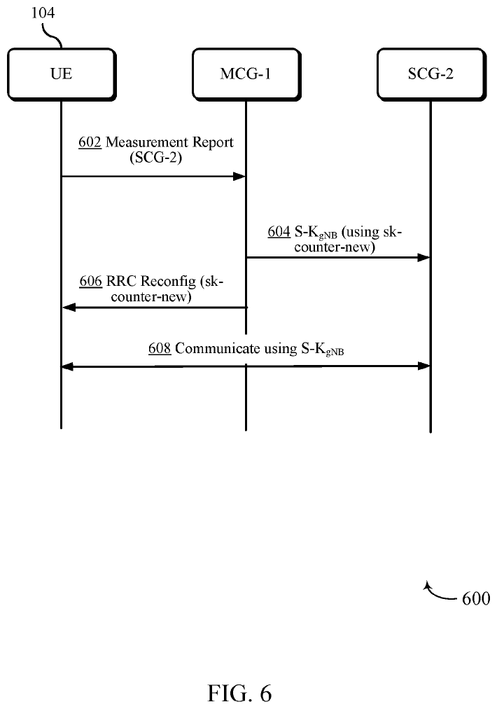

FIG. 6 illustrates a system 600 that supports key for connectivity to a cell group in accordance with aspects of the present disclosure. In implementations, a UE informs the master cell group (PCell) about an impending L1/L2 mobility to a previously visited PSCell and/or SCG. For instance, in the system 500, the UE 104 determines, while the UE 104 is still on SCG-4, that the radio quality measurement of one of the Scells of SCG-2 exceeds a quality threshold and/or the UE 104 initiates or is about to initiate the L1/L2 mobility towards the SCG-2. Accordingly, in the system 600, at step 602 the UE 104 may inform the MCG-1 (e.g., PCell) about an impending L1/L2 mobility using a L1, L2, or L3 (RRC) measurement reporting and/or may use a new signalling e.g., a new MAC control element (CE) or a L1 reporting on physical uplink control channel (PUCCH). Upon receiving this information, at 604 MCG-1 (e.g., PCell) may provide a new key S-K_{gNB}generated using an sk-counter-new signaled from the MCG-1 (e.g., MN) to the SCG-2 along with UE identity/ Xn context so that the intended PSCell and/or SCG-2 can derive the security keys for the UE 104 using the correct counter value. Further, at 606 MCG-1 may provide the new sk-counter (e.g., sk-counter-new) to the UE 104 that is to be used for mobility to the intended (previously visited) /Cell/ SCG-2, such as using an RRC Reconfiguration message, a new MAC CE, and/or other signaling type. At 608 the UE 104 connects to SCG-2 and the UE 104 and SCG-2 communicate (e.g., transmit and receive data) using S-K_{gNB}.

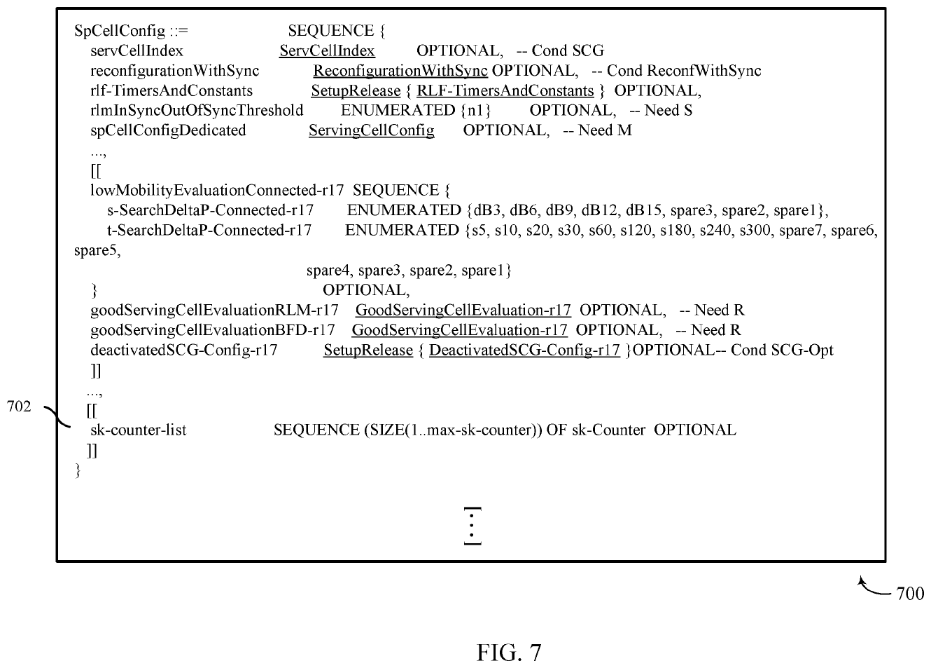

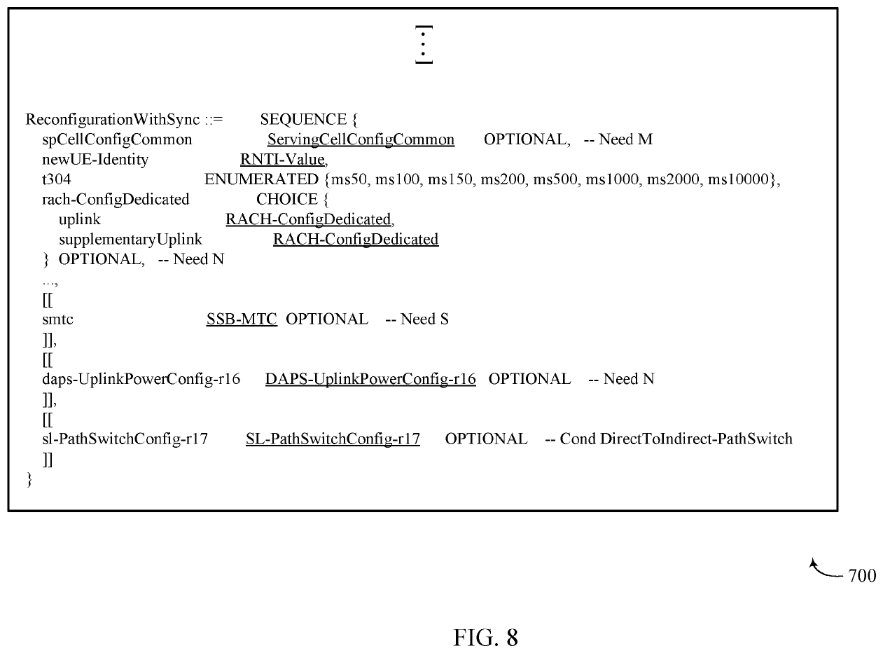

FIGS. 7 and 8 illustrate different respective portions of a message 700 that supports key for connectivity to a cell group in accordance with aspects of the present disclosure. In implementations, the message 700 may be implemented as an RRC reconfiguration message. For instance, consider that the RRC Reconfiguration contains ‘M’ SCG configurations (CellGroupConfig) and the MN of the MCG is preparing to provide a UE with more than one PSCell and/or SCG configurations. Accordingly, for each and/or some of the PSCell-M and/or SCG-M, the MN can provide ‘N’ (max-sk-counter≥N≥1) sk-counter_{M,N} that can be used sequentially, starting with sk-counter_{M,1}, one for each appearance of the UE in a PSCell and/or SCG. Thus, there may be more than one sk-counter included in CellGroupConfig for each included SCG. For instance, for each SCG configuration, CellGroupConfig includes ‘N’ sk-counter directly inside at the top level or as part of SpCellConfig for one or more corresponding PScell, such as illustrated in the field 702 of the message 700.

In an alternative or additional implementation, sk-counter-list can be included in Reconfiguration WithSync along with one or more new UE-Identity (as the value of ‘N’), such as one for each appearance of the UE in the PSCell. Further, a MN can send a list of S-K_{gNB} generated using the sk-counter-list, a first counter used to generate the first S-K_{gNB}, a second counter used to generate the second S-K_{gNB}, and so on, to the SCG(s) included in the RRC Reconfiguration message (e.g., the message 700) generated for the UE. In implementations, the UE and the SCG (e.g., the UE 104 and the SCG-2 in the examples above) can discard the sk-counter that was used to derive the security keys upon the UE leaving SCG-2.

In implementations, a UE can inform a MN about an impending mobility to an already visited PSCell and/or SCG, upon which the MCG can initiate an intra-cell handover procedure to initiate a refresh of the master key K_{gNB} itself. For instance, in an intra-cell handover, the MN sends an RRC Reconfiguration (e.g., via the message 700) including ReconfigurationWithSync to and from the current serving cell index, e.g., using a current PCell as both a source cell and a target cell for the handover. Further, along with an intra-cell handover command, the MN can provide an sk-counter-list for each of the SCGs configured for L1/L2 mobility.

Alternatively or additionally, based on an intra-cell handover, sk-counters received previously (e.g., received before receiving the intra-cell handover command including ReconfigurationWithSync) are considered valid and can be used again (e.g., starting with the first counter provided for each SCG) to derive the security keys when needed. According to this implementation, the UE and the SCGs are to remember the sk-counter values (e.g., sk-counter-list) even after one or more of the sk-counter values have been used to derive security keys.

In alternative or additional implementations, a MAC CE can be used to signal the intra-cell handover command including ReconfigurationWithSync containing at least some of the information included in SpCellConfig, and remaining information (e.g., information elements (IEs) not provided using the MAC CE) can be used from a previously received (e.g., the last received) RRC Reconfiguration including the SCG.

In implementations, a UE and an SCG can increment (e.g., add 1 and/or a signalled offset to) a value of a received sk-counter for each instance of the UE revisiting the PSCell and/or SCG. For instance, a MN configures sk-counters for SCGs non-contiguously such that limited increments in the sk-counter will not result in an sk-counter configured for a different SCG, e.g., two different SCGs concurrently. The SCG and the UE can keep a last signalled value of the new UE-Identity, provided initially by the SCG transparently via the MCG, for subsequent visits unless a master gNB informs the SCG to release the configuration for the UE and/or until a timer at the SCG expires. In an alternative or additional implementation, more than one new UE-Identity may have been provided, one for each appearance in sequence of the UE in the PSCell and/or SCG.

In implementations described above, a UE may determine if a candidate and/or target cell (e.g., Scell) for mobility belongs to a particular SCG. For this purpose, a UE can determine to which SCG, in the last received RRC reconfiguration, the PCI or CellIdentity of the candidate and/or target cell belongs to. Further, an SCG can store previous UE-Identities and a new UE-Identity to be used for the same UE, such as to enable different UE-Identities to be distinguished.

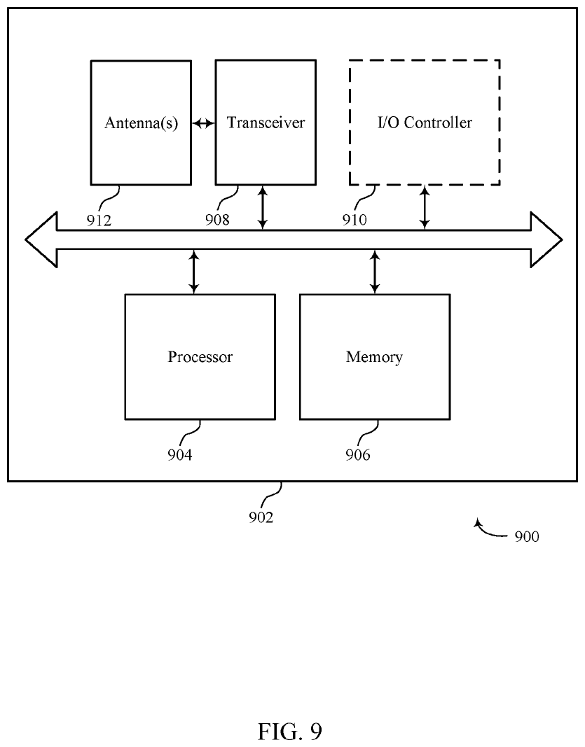

FIG. 9 illustrates an example of a block diagram 900 of a device 902 (e.g., an apparatus) that supports key for connectivity to a cell group in accordance with aspects of the present disclosure. The device 902 may be an example of UE 104 as described herein. The device 902 may support wireless communication with one or more network entities 102, UEs 104, or any combination thereof. The device 902 may include components for bi-directional communications including components for transmitting and receiving communications, such as a processor 904, a memory 906, a transceiver 908, and an I/O controller 910. These components may be in electronic communication or otherwise coupled (e.g., operatively, communicatively, functionally, electronically, electrically) via one or more interfaces (e.g., buses).

The processor 904, the memory 906, the transceiver 908, or various combinations thereof or various components thereof may be examples of means for performing various aspects of the present disclosure as described herein. For example, the processor 904, the memory 906, the transceiver 908, or various combinations or components thereof may support a method for performing one or more of the operations described herein.

In some implementations, the processor 904, the memory 906, the transceiver 908, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 904 and the memory 906 coupled with the processor 904 may be configured to perform one or more of the functions described herein (e.g., executing, by the processor 904, instructions stored in the memory 906). In the context of UE 104, for example, the transceiver 908 and the processor coupled 904 coupled to the transceiver 908 are configured to cause the UE 104 to perform the various described operations and/or combinations thereof.

For example, the processor 904 and/or the transceiver 908 may support wireless communication at the device 902 in accordance with examples as disclosed herein. For instance, the processor 904 and/or the transceiver 908 may be configured as and/or otherwise support a means to initiate a connectivity procedure to connect to a secondary cell of a first cell group; update a security counter value associated with the first cell group based at least in part on an indication that the UE previously connected to a different cell group; generate, based at least in part on the updated security counter value, a security key for the first cell group; and implement data transmission to the secondary cell of the first cell group using the security key.

Further, in some implementations, the processor is further configured to receive configuration information for connectivity between multiple cell groups, the configuration information includes the security counter value for the first cell group and one or more other security counter values for one or more other cell groups of the multiple cell groups; the processor is further configured to: determine that the UE previously connected to a different cell group subsequently to receiving the configuration information; and generate the security key using the updated security counter value based at least in part on the determination that the UE previously connected to a different cell group subsequently to receiving the configuration information; the processor is further configured to: receive the configuration information from a master cell group, the configuration information includes configuration information for primary secondary cells for the multiple cell groups.

Further, in some implementations, the processor is further configured to: perform one or more measurements of one or more measurement objects associated with the first cell group; and initiate the connectivity procedure based on least in part on the one or more measurements corresponding to a criterion; the processor is further configured to receive RRC configuration identifying the one or more measurement objects; the processor is further configured to initiate the connectivity procedure via a lower level mobility procedure; the updated security counter value includes a security counter value not previously used by the UE for connectivity to the first cell group; the processor is further configured to implement the data transmission using the security key to secure data transmission over one or more bearers served by the first cell group; to update the security counter value, the processor is further configured to increment the security counter value to generate the updated security counter value; the processor is further configured to receive a specified offset value, and to increment the security counter value by the specified offset value to generate the updated security counter value.

In a further example, the processor 904 and/or the transceiver 908 may support wireless communication at the device 902 in accordance with examples as disclosed herein. The processor 904 and/or the transceiver 908, for instance, may be configured as or otherwise support a means to transmit, to a master node of a master cell group, an indication that the UE initiates a connectivity procedure to connect to a secondary cell of a first cell group; receive a notification to perform an intra-cell handover with a primary cell of the master cell group; implement the intra-cell handover with the primary cell using a master key generated using a received next hop count; receive a security counter value from the primary cell; and generate a security key using the security counter value and implement data transmission to the secondary cell of the first cell group using the security key.

Further, in some implementations, the indication further indicates that the UE previously connected to the secondary cell of the first cell group; the processor is further configured to receive multiple security counter values for multiple secondary cells groups including the first cell group; the notification to perform the intra-cell handover includes an indication to use the primary cell as both a source cell and a target cell for the intra-cell handover.

The processor 904 of the device 902, such as a UE 104, may support wireless communication in accordance with examples as disclosed herein. The processor 904 includes at least one controller coupled with at least one memory and is configured to and/or operable to cause the processor to perform various operations described herein with reference to the device 902, e.g., a UE 104. For instance, the processor 904 is configurable to and/or operable to initiate a connectivity procedure to connect to a secondary cell of a first cell group; update a security counter value associated with the first cell group based at least in part on an indication that the UE previously connected to a different cell group; generate, based at least in part on the updated security counter value, a security key for the first cell group; and implement data transmission to the secondary cell of the first cell group using the security key.

The processor 904 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 904 may be configured to operate a memory array using a memory controller. In some other implementations, a memory controller may be integrated into the processor 904. The processor 904 may be configured to execute computer-readable instructions stored in a memory (e.g., the memory 906) to cause the device 902 to perform various functions of the present disclosure.

The memory 906 may include random access memory (RAM) and read-only memory (ROM). The memory 906 may store computer-readable, computer-executable code including instructions that, when executed by the processor 904 cause the device 902 to perform various functions described herein. The code may be stored in a non-transitory computer-readable medium such as system memory or another type of memory. In some implementations, the code may not be directly executable by the processor 904 but may cause a computer (e.g., when compiled and executed) to perform functions described herein. In some implementations, the memory 906 may include, among other things, a basic I/O system (BIOS) which may control basic hardware or software operation such as the interaction with peripheral components or devices.

The I/O controller 910 may manage input and output signals for the device 902. The I/O controller 910 may also manage peripherals not integrated into the device M02. In some implementations, the I/O controller 910 may represent a physical connection or port to an external peripheral. In some implementations, the I/O controller 910 may utilize an operating system such as iOS®, ANDROID®, MS-DOS®, MS-WINDOWS®, OS/2®, UNIX®, LINUX®, or another known operating system. In some implementations, the I/O controller 910 may be implemented as part of a processor, such as the processor M08. In some implementations, a user may interact with the device 902 via the I/O controller 910 or via hardware components controlled by the I/O controller 910.

In some implementations, the device 902 may include a single antenna 912. However, in some other implementations, the device 902 may have more than one antenna 912 (e.g., multiple antennas), including multiple antenna panels or antenna arrays, which may be capable of concurrently transmitting or receiving multiple wireless transmissions. The transceiver 908 may communicate bi-directionally, via the one or more antennas 912, wired, or wireless links as described herein. For example, the transceiver 908 may represent a wireless transceiver and may communicate bi-directionally with another wireless transceiver. The transceiver 908 may also include a modem to modulate the packets, to provide the modulated packets to one or more antennas 912 for transmission, and to demodulate packets received from the one or more antennas 912.

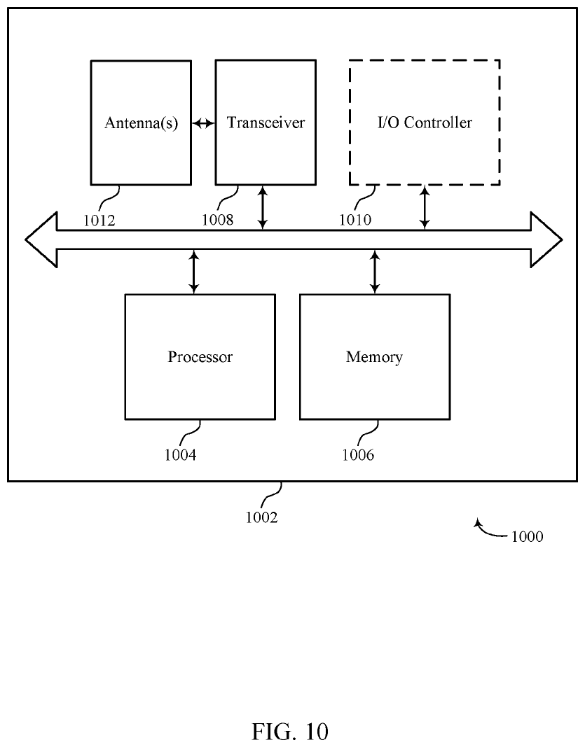

FIG. 10 illustrates an example of a block diagram 1000 of a device 1002 (e.g., an apparatus) that supports key for connectivity to a cell group in accordance with aspects of the present disclosure. The device 1002 may be an example of a network entity 102 as described herein. The device 1002 may support wireless communication with one or more network entities 102, UEs 104, or any combination thereof. The device 1002 may include components for bi-directional communications including components for transmitting and receiving communications, such as a processor 1004, a memory 1006, a transceiver 1008, and an I/O controller 1010. These components may be in electronic communication or otherwise coupled (e.g., operatively, communicatively, functionally, electronically, electrically) via one or more interfaces (e.g., buses).

The processor 1004, the memory 1006, the transceiver 1008, or various combinations thereof or various components thereof may be examples of means for performing various aspects of the present disclosure as described herein. For example, the processor 1004, the memory 1006, the transceiver 1008, or various combinations or components thereof may support a method for performing one or more of the operations described herein.

In some implementations, the processor 1004, the memory 1006, the transceiver 1008, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1004 and the memory 1006 coupled with the processor 1004 may be configured to perform one or more of the functions described herein (e.g., executing, by the processor 1004, instructions stored in the memory 1006). In the context of network entity 102, for example, the transceiver 1008 and the processor 1004 coupled to the transceiver 1008 are configured to cause the network entity 102 to perform the various described operations and/or combinations thereof.

For example, the processor 1004 and/or the transceiver 1008 may support wireless communication at the device 1002 in accordance with examples as disclosed herein. For instance, the processor 1004 and/or the transceiver 1008 may be configured as or otherwise support a means to receive an indication that a user equipment (UE) initiates a connectivity procedure to connect to a secondary cell of a first cell group; transmit, to the first cell group, a security key; and transmit, to the UE, a security counter value used to generate the security key.

Further, in some implementations, the processor is further configured to transmit, to the UE, configuration information for connectivity between multiple cell groups, the configuration information includes the security counter value for the first cell group and one or more other security counter values for one or more other cell groups of the multiple cell groups; the apparatus includes a master node of a master cell group, and the configuration information includes configuration information for primary secondary cells for the multiple cell groups; the processor is configured to generate the security counter value for the first cell group and the one or more other security counter values for the one or more other cell groups as non-contiguous values; processor is configured to receive the indication that the UE initiates the connectivity procedure while the UE is connected to a second secondary cell group of the multiple cell groups; the processor is configured to transmit the configuration information to the UE via RRC signaling; the processor is further configured to transmit, to the UE, configuration information including one or more measurement objects and one or more criteria for connectivity to the secondary cell of the first cell group; the indication indicates that the UE initiates the connectivity procedure via a lower layer mobility procedure; the indication indicates that the UE previously connected to the secondary cell of the first cell group.

In a further example, the processor 1004 and/or the transceiver 1008 may support wireless communication at the device 1002 in accordance with examples as disclosed herein. The processor 1004 and/or the transceiver 1008, for instance, may be configured as or otherwise support a means to receive, at a primary cell of a master cell group, an indication that a user equipment (UE) initiates a connectivity procedure to connect to a secondary cell of a first cell group; initiate an intra-cell handover between the UE and the primary cell of the master cell group to generate an updated master key of the master cell group using a next hop count; transmit, to the first cell group, a secondary key generated based at least in part on the updated master key; and transmit a security counter value used to generate the secondary key to the UE.

Further, in some implementations, to initiate the intra-cell handover, the processor is configured to transmit a notification to the UE to use the primary cell as both a source cell and a target cell for the intra-cell handover; the master cell group includes multiple cell groups, and the processor is further configured to transmit, to the UE, multiple security counter values for the multiple cell groups.

In a further example, the processor 1004 and/or the transceiver 1008 may support wireless communication at the device 1002 in accordance with examples as disclosed herein. The processor 1004 and/or the transceiver 1008, for instance, may be configured as or otherwise support a means to receive, at a first cell group and from a master cell group, a security counter value; receive an indication that a user equipment (UE) initiates a connectivity procedure to connect to a secondary cell of the first cell group; increment the security counter value to generate an updated security counter value; and implement data transmission with the UE using a security key generated using the updated security counter value.

Further, in some implementations, the processor is further configured to receive a specified offset value, and to increment the security counter value by the specified offset value to generate the updated security counter value; the processor is further configured to: determine that the UE previously connected to the first cell group using the security counter value; determine that the connectivity procedure represents a reconnection of the UE to the first cell group; and increment the security counter value to generate the updated security counter value based at least in part on the reconnection of the UE to the first cell group.

The processor 1004 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1004 may be configured to operate a memory array using a memory controller. In some other implementations, a memory controller may be integrated into the processor 1004. The processor 1004 may be configured to execute computer-readable instructions stored in a memory (e.g., the memory 1006) to cause the device 1002 to perform various functions of the present disclosure.

The memory 1006 may include random access memory (RAM) and read-only memory (ROM). The memory 1006 may store computer-readable, computer-executable code including instructions that, when executed by the processor 1004 cause the device 1002 to perform various functions described herein. The code may be stored in a non-transitory computer-readable medium such as system memory or another type of memory. In some implementations, the code may not be directly executable by the processor 1004 but may cause a computer (e.g., when compiled and executed) to perform functions described herein. In some implementations, the memory 1006 may include, among other things, a basic I/O system (BIOS) which may control basic hardware or software operation such as the interaction with peripheral components or devices.

The I/O controller 1010 may manage input and output signals for the device 1002. The I/O controller 1010 may also manage peripherals not integrated into the device M02. In some implementations, the I/O controller 1010 may represent a physical connection or port to an external peripheral. In some implementations, the I/O controller 1010 may utilize an operating system such as iOS®, ANDROID®, MS-DOS®, MS-WINDOWS®, OS/2®, UNIX®, LINUX®, or another known operating system. In some implementations, the I/O controller 1010 may be implemented as part of a processor, such as the processor M06. In some implementations, a user may interact with the device 1002 via the I/O controller 1010 or via hardware components controlled by the I/O controller 1010.

In some implementations, the device 1002 may include a single antenna 1012. However, in some other implementations, the device 1002 may have more than one antenna 1012 (e.g., multiple antennas), including multiple antenna panels or antenna arrays, which may be capable of concurrently transmitting or receiving multiple wireless transmissions. The transceiver 1008 may communicate bi-directionally, via the one or more antennas 1012, wired, or wireless links as described herein. For example, the transceiver 1008 may represent a wireless transceiver and may communicate bi-directionally with another wireless transceiver. The transceiver 1008 may also include a modem to modulate the packets, to provide the modulated packets to one or more antennas 1012 for transmission, and to demodulate packets received from the one or more antennas 1012.

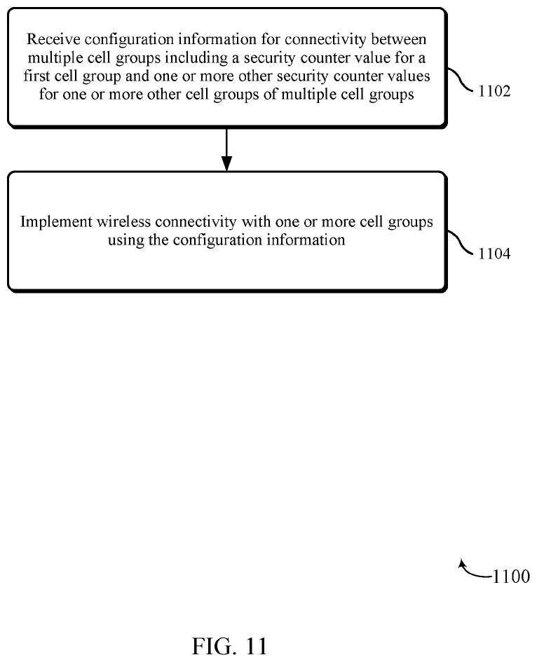

FIG. 11 illustrates a flowchart of a method 1100 that supports key for connectivity to a cell group in accordance with aspects of the present disclosure. The operations of the method 1100 may be implemented by a device or its components as described herein. For example, the operations of the method 1100 may be performed by a UE 104 as described with reference to FIGS. 1 through 10. In some implementations, the device may execute a set of instructions to control the function elements of the device to perform the described functions. Additionally, or alternatively, the device may perform aspects of the described functions using special-purpose hardware.

At 1102, the method may include receiving configuration information for connectivity between multiple cell groups including a security counter value for a first cell group and one or more other security counter values for one or more other cell groups of multiple cell groups. The operations of 1102 may be performed in accordance with examples as described herein. In some implementations, aspects of the operations of 1102 may be performed by a device as described with reference to FIG. 1.

At 1104, the method may include implementing wireless connectivity with one or more cell groups using the configuration information. The operations of 1104 may be performed in accordance with examples as described herein. In some implementations, aspects of the operations of 1104 may be performed by a device as described with reference to FIG. 1.

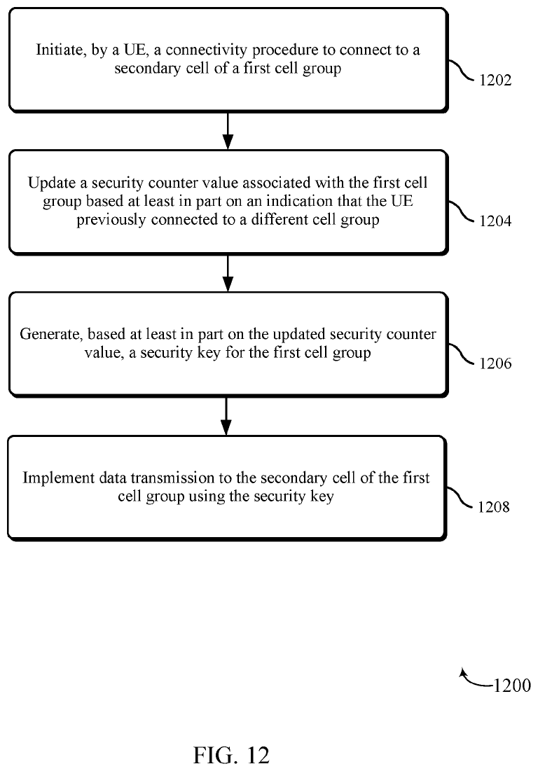

FIG. 12 illustrates a flowchart of a method 1200 that supports key for connectivity to a cell group in accordance with aspects of the present disclosure. The operations of the method 1200 may be implemented by a device or its components as described herein. For example, the operations of the method 1200 may be performed by a UE 104 as described with reference to FIGS. 1 through 10. In some implementations, the device may execute a set of instructions to control the function elements of the device to perform the described functions. Additionally, or alternatively, the device may perform aspects of the described functions using special-purpose hardware.

At 1202, the method may include initiating, by a UE, a connectivity procedure to connect to a secondary cell of a first cell group. The operations of 1202 may be performed in accordance with examples as described herein. In some implementations, aspects of the operations of 1202 may be performed by a device as described with reference to FIG. 1.

At 1204, the method may include updating a security counter value associated with the first cell group based at least in part on an indication that the UE previously connected to a different cell group. The operations of 1204 may be performed in accordance with examples as described herein. In some implementations, aspects of the operations of 1204 may be performed by a device as described with reference to FIG. 1.

At 1206, the method may include generating, based at least in part on the updated security counter value, a security key for the first cell group. The operations of 1206 may be performed in accordance with examples as described herein. In some implementations, aspects of the operations of 1206 may be performed by a device as described with reference to FIG. 1.

At 1208, the method may include implementing data transmission to the secondary cell of the first cell group using the security key. The operations of 1208 may be performed in accordance with examples as described herein. In some implementations, aspects of the operations of 1208 may be performed by a device as described with reference to FIG. 1.

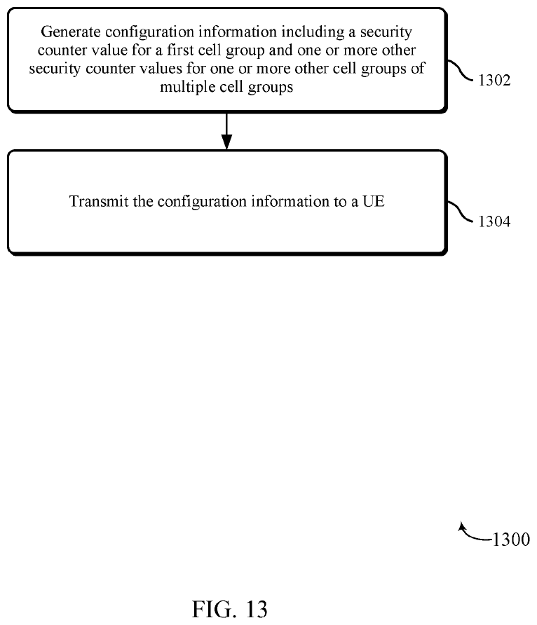

FIG. 13 illustrates a flowchart of a method 1300 that supports key for connectivity to a cell group in accordance with aspects of the present disclosure. The operations of the method 1300 may be implemented by a device or its components as described herein. For example, the operations of the method 1300 may be performed by a network entity 102 as described with reference to FIGS. 1 through 10. In some implementations, the device may execute a set of instructions to control the function elements of the device to perform the described functions. Additionally, or alternatively, the device may perform aspects of the described functions using special-purpose hardware.

At 1302, the method may include generating configuration information including a security counter value for a first cell group and one or more other security counter values for one or more other cell groups of multiple cell groups. The operations of 1302 may be performed in accordance with examples as described herein. In some implementations, aspects of the operations of 1302 may be performed by a device as described with reference to FIG. 1.

At 1304 , the method may include transmitting the configuration information to a UE.

The operations of 1304 may be performed in accordance with examples as described herein. In some implementations, aspects of the operations of 1304 may be performed by a device as described with reference to FIG. 1.

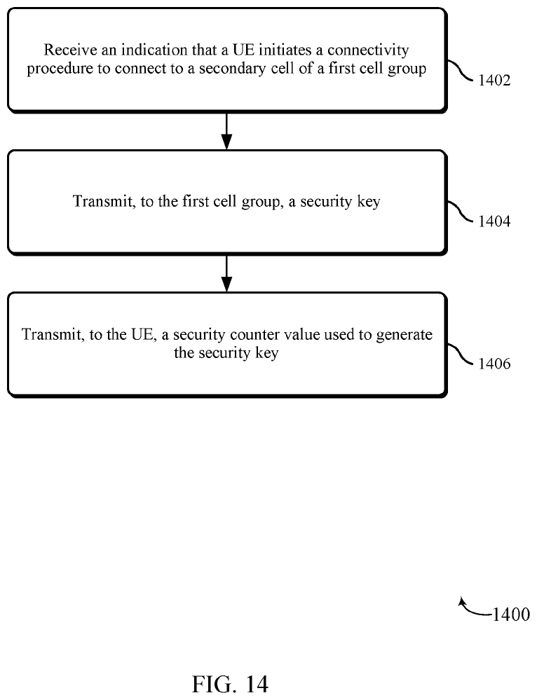

FIG. 14 illustrates a flowchart of a method 1400 that supports key for connectivity to a cell group in accordance with aspects of the present disclosure. The operations of the method 1400 may be implemented by a device or its components as described herein. For example, the operations of the method 1400 may be performed by a network entity 102 as described with reference to FIGS. 1 through 10. In some implementations, the device may execute a set of instructions to control the function elements of the device to perform the described functions. Additionally, or alternatively, the device may perform aspects of the described functions using special-purpose hardware.

At 1402, the method may include receiving an indication that a UE initiates a connectivity procedure to connect to a secondary cell of a first cell group. The operations of 1402 may be performed in accordance with examples as described herein. In some implementations, aspects of the operations of 1402 may be performed by a device as described with reference to FIG. 1.

At 1404, the method may include transmitting, to the first cell group, a security key. The operations of 1404 may be performed in accordance with examples as described herein. In some implementations, aspects of the operations of 1404 may be performed by a device as described with reference to FIG. 1.

At 1406, the method may include transmitting, to the UE, a security counter value used to generate the security key. The operations of 1406 may be performed in accordance with examples as described herein. In some implementations, aspects of the operations of 1406 may be performed by a device as described with reference to FIG. 1.

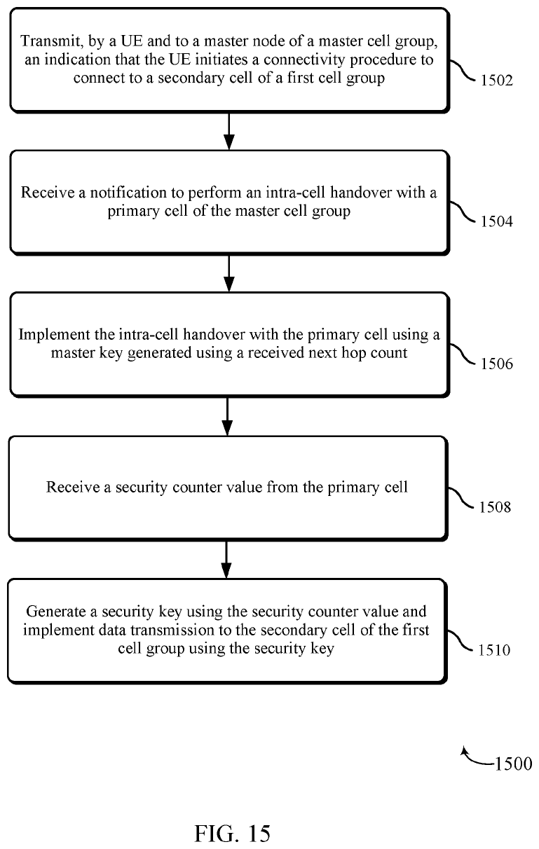

FIG. 15 illustrates a flowchart of a method 1500 that supports key for connectivity to a cell group in accordance with aspects of the present disclosure. The operations of the method 1500 may be implemented by a device or its components as described herein. For example, the operations of the method 1500 may be performed by a UE 104 as described with reference to FIGS. 1 through 10. In some implementations, the device may execute a set of instructions to control the function elements of the device to perform the described functions. Additionally, or alternatively, the device may perform aspects of the described functions using special-purpose hardware.

At 1502, the method may include transmitting, by a UE and to a master node of a master cell group, an indication that the UE initiates a connectivity procedure to connect to a secondary cell of a first cell group. The operations of 1502 may be performed in accordance with examples as described herein. In some implementations, aspects of the operations of 1502 may be performed by a device as described with reference to FIG. 1.

At 1504, the method may include receiving a notification to perform an intra-cell handover with a primary cell of the master cell group. The operations of 1504 may be performed in accordance with examples as described herein. In some implementations, aspects of the operations of 1504 may be performed by a device as described with reference to FIG. 1.

At 1506, the method may include implementing the intra-cell handover with the primary cell using a master key generated using a received next hop count. The operations of 1506 may be performed in accordance with examples as described herein. In some implementations, aspects of the operations of 1506 may be performed by a device as described with reference to FIG. 1.

At 1508, the method may include receive a security counter value from the primary cell. The operations of 1508 may be performed in accordance with examples as described herein. In some implementations, aspects of the operations of 1508 may be performed by a device as described with reference to FIG. 1.

At 1510, the method may include generating a security key using the security counter value and implement data transmission to the secondary cell of the first cell group using the security key. The operations of 1510 may be performed in accordance with examples as described herein. In some implementations, aspects of the operations of 1510 may be performed by a device as described with reference to FIG. 1.

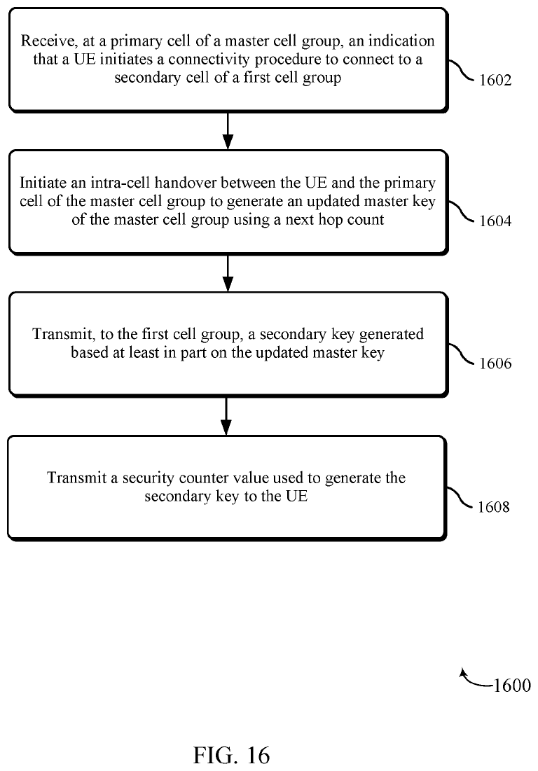

FIG. 16 illustrates a flowchart of a method 1600 that supports key for connectivity to a cell group in accordance with aspects of the present disclosure. The operations of the method 1600 may be implemented by a device or its components as described herein. For example, the operations of the method 1600 may be performed by a network entity 102 as described with reference to FIGS. 1 through 10. In some implementations, the device may execute a set of instructions to control the function elements of the device to perform the described functions. Additionally, or alternatively, the device may perform aspects of the described functions using special-purpose hardware.

At 1602, the method may include receiving, at a primary cell of a master cell group, an indication that a UE initiates a connectivity procedure to connect to a secondary cell of a first cell group. The operations of 1602 may be performed in accordance with examples as described herein. In some implementations, aspects of the operations of 1602 may be performed by a device as described with reference to FIG. 1.

At 1604, the method may include initiating an intra-cell handover between the UE and the primary cell of the master cell group to generate an updated master key of the master cell group using a next hop count. The operations of 1604 may be performed in accordance with examples as described herein. In some implementations, aspects of the operations of 1604 may be performed by a device as described with reference to FIG. 1.

At 1606, the method may include transmitting, to the first cell group, a secondary key generated based at least in part on the updated master key. The operations of 1606 may be performed in accordance with examples as described herein. In some implementations, aspects of the operations of 1606 may be performed by a device as described with reference to FIG. 1.

At 1608, the method may include transmitting a security counter value used to generate the secondary key to the UE. The operations of 1608 may be performed in accordance with examples as described herein. In some implementations, aspects of the operations of 1608 may be performed by a device as described with reference to FIG. 1.

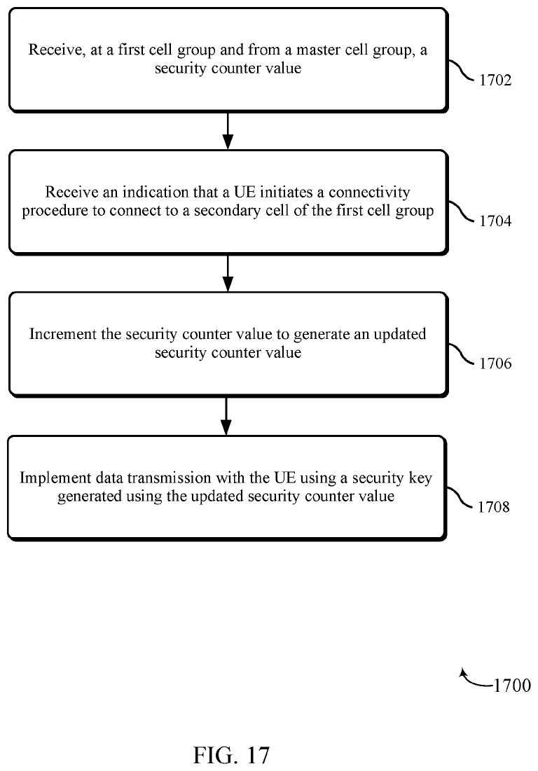

FIG. 17 illustrates a flowchart of a method 1700 that supports key for connectivity to a cell group in accordance with aspects of the present disclosure. The operations of the method 1700 may be implemented by a device or its components as described herein. For example, the operations of the method 1700 may be performed by a network entity 102 as described with reference to FIGS. 1 through 10. In some implementations, the device may execute a set of instructions to control the function elements of the device to perform the described functions. Additionally, or alternatively, the device may perform aspects of the described functions using special-purpose hardware.

At 1702, the method may include receiving, at a first cell group and from a master cell group, a security counter value. The operations of 1702 may be performed in accordance with examples as described herein. In some implementations, aspects of the operations of 1702 may be performed by a device as described with reference to FIG. 1.

At 1704, the method may include receiving an indication that a UE initiates a connectivity procedure to connect to a secondary cell of the first cell group. The operations of 1704 may be performed in accordance with examples as described herein. In some implementations, aspects of the operations of 1704 may be performed by a device as described with reference to FIG. 1.

At 1706, the method may include incrementing the security counter value to generate an updated security counter value. The operations of 1706 may be performed in accordance with examples as described herein. In some implementations, aspects of the operations of 1706 may be performed by a device as described with reference to FIG. 1.

At 1708, the method may include implementing data transmission with the UE using a security key generated using the updated security counter value. The operations of 1708 may be performed in accordance with examples as described herein. In some implementations, aspects of the operations of 1708 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (e.g., A and B and C). Also, as used herein, the phrase “based on” cannot be construed as a reference to a closed set of conditions. For example, an example step that is described as “based on condition A” may be based on both a condition A and a condition B without departing from the scope of the present disclosure. In other words, as used herein, the phrase “based on” can be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
initiate a connectivity procedure to connect to a secondary cell of a first cell group;
update a security counter value associated with the first cell group based at least in part on a determination that the UE previously connected to a different cell group;
generate, based at least in part on the updated security counter value, a security key for the first cell group; and
implement data transmission to the secondary cell of the first cell group using the security key.

2. The UE of claim 1, wherein the at least one processor is operable to cause the UE to receive configuration information for connectivity between multiple cell groups, wherein the configuration information comprises one or more security counter values for the first cell group and one or more other security counter values for one or more other cell groups of the multiple cell groups.

3. The UE of claim 2, wherein the at least one processor is operable to cause the UE to:
determine that the UE previously connected to the first cell group subsequently to receiving the configuration information; and
generate the security key using the updated security counter value based at least in part on the determination that the UE previously connected to the first cell group subsequently to receiving the configuration information.

4. The UE of claim 2, wherein the at least one processor is operable to cause the UE to:
receive the configuration information from a master cell group, wherein the configuration information comprises configuration information for primary secondary cells for the multiple cell groups.

5. The UE of claim 1, wherein the at least one processor is operable to cause the UE to:
perform one or more measurements of one or more measurement objects associated with the first cell group; and
initiate the connectivity procedure based on least in part on the one or more measurements corresponding to a criterion.

6. The UE of claim 5, wherein the at least one processor is operable to cause the UE to receive radio resource control (RRC) configuration identifying the one or more measurement objects.

7. The UE of claim 1, wherein the at least one processor is operable to cause the UE to initiate the connectivity procedure via a lower level mobility procedure.

8. The UE of claim 1, wherein the updated security counter value comprises a security counter value not previously used by the UE for connectivity to the first cell group.

9. The UE of claim 1, wherein the at least one processor is operable to cause the UE to implement the data transmission using the security key to secure data transmission over one or more bearers served by the first cell group.

10. The UE of claim 1, wherein to update the security counter value, the at least one processor is operable to cause the UE to increment the security counter value to generate the updated security counter value.

11. The UE of claim 10, wherein the at least one processor is operable to cause the UE to receive a specified offset value, and to increment the security counter value by the specified offset value to generate the updated security counter value.

12. A network entity for wireless communication, comprising:
at least one memory; and
at least one processor coupled with the at least one memory and operable to cause the network entity to:
receive an indication that a user equipment (UE) initiates a connectivity procedure to connect to a secondary cell of a first cell group; and
transmit, to the first cell group, a security key.

13. The network entity of claim 12, wherein the at least one processor is operable to cause the network entity to transmit, to the UE, configuration information for connectivity between multiple cell groups, wherein the configuration information comprises security counter values for the first cell group and one or more other security counter values for one or more other cell groups of the multiple cell groups.

14. The network entity of claim 13, wherein the network entity comprises a master node of a master cell group, and wherein the configuration information comprises configuration information for primary secondary cells for the multiple cell groups.

15. The network entity of claim 13, wherein the at least one processor is operable to cause the network entity to generate the security counter value for the first cell group and the one or more other security counter values for the one or more other cell groups as non-contiguous values.

16. (canceled)

17. (canceled)

18. (canceled)

19. A processor for wireless communication, comprising:
at least one controller coupled with at least one memory and operable to cause the processor to:
initiate a connectivity procedure to connect to a secondary cell of a first cell group;
update a security counter value associated with the first cell group based at least in part on an indication that a user equipment (UE) previously connected to the first cell group;
generate, based at least in part on the updated security counter value, a security key for the first cell group; and
implement data transmission to the secondary cell of the first cell group using the security key.

20. A method performed by a user equipment (UE), the method comprising:
initiating a connectivity procedure to connect to a secondary cell of a first cell group;
updating a security counter value associated with the first cell group based at least in part on a determination that the UE previously connected to a different cell group;
generating, based at least in part on the updated security counter value, a security key for the first cell group; and
implementing data transmission to the secondary cell of the first cell group using the security key.

21. The method of claim 20, further comprising receiving configuration information for connectivity between multiple cell groups, wherein the configuration information comprises one or more security counter values for the first cell group and one or more other security counter values for one or more other cell groups of the multiple cell groups.

22. The method of claim 21, further comprising receiving the configuration information from a master cell group, wherein the configuration information comprises configuration information for primary secondary cells for the multiple cell groups.

23. The method of claim 20, wherein the updated security counter value comprises a security counter value not previously used by the UE for connectivity to the first cell group.
